(19) United States
(12) Patent Application Publication
(10) Pub. No.: US 2010/0141674 A1
(43) Pub. Date: Jun. 10, 2010

(54) DISPLAY DEVICE

(75) Inventors: Takatoshi OHARA, Kokubunji (JP); Masanori TAKEUCHI, Tokyo (JP); Hiroyuki NITTA, Fujisawa (JP); Yasuhiro AKIYAMA, Ome (JP)

Correspondence Address: MATTINGLY & MALUR, P.C., 1800 DIAGONAL ROAD, SUITE 370, ALEXANDRIA, VA, 22314, US

(73) Assignee: HITACHI CONSUMER ELECTRONICS CO., LTD., Tokyo (JP)

(21) Appl. No.: 12/628,348

(22) Filed: Dec. 1, 2009

(30) Foreign Application Priority Data
Dec. 8, 2008 (JP) 2008-311715

(51) Int. Cl. G09G 5/02; H04N 7/00

(52) U.S. Cl. 345/589; 348/699; 348/E07.001

(57) ABSTRACT

The disclosed invention provides a display device for performing a gradation display, using a plurality of subframes of image into which one frame of image is divided, and a display method that reduces dynamic false contour noises occurring when the image is displayed and is suitable for plasma display panels and the like. Dynamic false contour noise reduction is performed by detecting luminance on/off state change (carry up/carry down) in a region where a smooth tone level change occurs and interchanging the tone values of pixels in the region. The reduction processing is controlled, based on an amount of motion of an original image and a display load ratio, so that dynamic false contour noise reduction is performed favorably. By carrying out different ways of processing for each frame, noise reduction in the time domain is performed.

### CLAIM OF PRIORITY

The present application claims priority from Japanese patent application JP 2008-311715 filed on Dec. 8, 2008, the content of which is hereby incorporated by reference into this application.

### FIELD OF THE INVENTION

The present invention relates to a display device for performing a gradation display by making up one frame of a plurality of subframes arranged in a predetermined order on a time axis, giving each subframe a luminance weight corresponding to a tone level, and controlling lighting or non-lighting of pixels on a display panel for each subframe according to an image signal.

### BACKGROUND OF THE INVENTION

A digital display device such as a Plasma Display Panel (PDP) device that controls display of pixels on a display panel, based on digital signals of display data, displays an image, using a publicly known subframe technique. FIG. 1A is a diagram to explain an image display method based on the subframe technique, where temporal relations in a series of subframes in one frame are shown. These individual subframes are controlled in a predetermined way separately during different periods: a setup period T1 for preparatory discharge; a write period T2 for writing to each pixel data representing whether the pixel should be turned on or off, and a sustention period T3 for simultaneous lighting of pixels to which turn-on data was written during the write period. Each subframe is weighted respectively and the weight of each subframe is proportional to the amount of light emission in the subframe and is determined by the length of the above sustention period T3, that is, the number of sustained discharge cycles (called the number of sustention cycles). Then, a pattern of turning pixels on or off in a subframe is called a lighting pattern. Based on the above method, by selecting and combining subframes having different weights and calculating a total amount of the weights, it is possible to display a tone level corresponding to a luminance in an image signal.

In the above-mentioned subframe technique, however, when a moving image is displayed, because the line of sight of the viewer keeps track of the moving image, the lighting patterns that are integrated on the line of sight change and a peculiar contour noise is perceived with respect to the moving image. This contour noise is called a dynamic false contour noise and it is a factor of degrading the image quality perceived by the viewer, which is described in “New Category Contour Noise Observed in Pulse-Width-Modulated Moving Images”, the Institute of Image Information and Television Engineers, Technical Report Vol. 19, No. 2, IDY95-21, pp. 61-66.

FIG. 1B is a diagram to explain a cause of producing the above-mentioned dynamic false contour noise. Here, it is assumed that one frame consists of eight subframes and the subframes are weighted by powers of two in order. In a case where a still image is displayed in FIG. 1B, the line of sight of the viewer is oriented toward a direction such that integrating pixel turn-on and turn-off states in each subframe pixel by pixel takes place. So, the gradation of display of the pixels is perceived correctly. By contrast, when the image moves in an arrow direction indicated in the figure, the line of sight of the viewer follows the move and moves in the same direction that the image moves. The line of sight of the viewer at this time is oriented toward a direction such that integrating pixel turn-on and turn-off states in each subframe across a plurality of pixels takes place, as shown in FIG. 1B. Consequently, the gradation of display of the pixels is not perceived correctly, thus resulting in a noise.

This phenomena appears in a portion where pixel turn-on state significantly changes to turn-off and vice versa in each frame, i.e., where luminance on/off state change (weighting carry up) occurs in each subframe. Therefore, a method that inhibits the use of such a luminance on/off state change (weighting carry up) portion has been used heretofore.

Through the above method that inhibits the use of a subset of lighting patterns, it is possible to partially reduce dynamic false contour noises, but the number of available lighting patterns decreases. That is, because the number of displayable tones decreases, when a dynamic range of a gradation display is maintained, a smooth gradation characteristic is disordered and differences between tone levels become uneven and increase. To interpolate these differences between tone levels and accomplish a smooth gradation expression, an error diffusion method is used.

However, it is impossible to reduce all dynamic false counter noises only by the method that inhibits the use of a subset of lighting patterns. As a method for reducing remaining dynamic false counter noises, a method that determines pixels inducing a dynamic false counter noise, based on monotonicity of tone level change, whether or not luminance on/off state change (carry up/carry down) occurs in a subframe, and a contour position, and disperses the factor of producing the dynamic false counter noise by a pixel value interchanger is disclosed in Japanese Patent Application Laid-Open Publication No. 2005-301302.

This method detects a luminance on/off state change (carry up/carry down) pattern in a subframe within a certain range and determines the detected pattern to be a pattern inducing a dynamic false contour noise on the condition that tone level changes monotonously and the pattern is not positioned on a contour. The method realizes dynamic false counter noise reduction by interchanging the tone values of pixels in the determined pattern inducing a dynamic false contour noise and by alternately arranging a tone made brighter (darker) than in the original image and a tone made darker (brighter) than in the original image.

In this method, however, a detection range for detecting a luminance on/off state change (carry up/carry down) portion in a subframe and a range of tone value interchange processing are constant independently of an amount of motion of an original image signal.

With regard to pixel value interchange processing in the related art method, the same way of interchange processing is carried out for all frames.

### SUMMARY OF THE INVENTION

As described above, with regard to a display device carrying out a gradation expression based on the subframe technique, the lighting patterns are curtailed for the purpose of dynamic false counter noise reduction. For dynamic false counter noises that cannot be eliminated by the noise reduction method by curtailing the lighting patterns, the related art method has proposed dynamic false counter noise reduction by tone dispersion in a luminance on/off state change (carry up/carry down) portion in a subframe. In this method, however, motion of an original image is not taken into account and, therefore, the range of pixel value interchange processing is constant independently of an amount of motion of an original image signal.

Consequently, in the related art method, due to variation in the amount of motion of an original image, dynamic false counter noise reduction processing may not be applied in a region inducing a dynamic false counter noise or pixel value interchange processing may be applied in a region not inducing a dynamic false counter noise. This method has a problem that image quality varies, as the amount of motion varies.

With regard to the pixel value interchange processing in the related art method, the same way of interchange processing is carried out for all frames. Although dynamic false counter noise reduction in the space domain is feasible by the pixel value interchange processing, another problem of this method is that identical tone patterns continuing over a plurality of frames are perceived as a noise, because the same way of processing is carried out for all frames.

To address the above-noted problems, the present invention resides in a display device for displaying a gradation by making up one frame of a plurality of subframes having different weights of luminance and combining luminances of the subframes. The display device comprises a motion amount detecting unit that detects an amount of motion of an input image to be displayed, a luminance on/off state change detecting unit that detects a luminance on/off state change (carry up/carry down) point of per-pixel lighting in at least a subframe having the largest weight of luminance among subframes in which contiguous pixels are lighted up, and a pixel value interchanging unit that interchanges the tone values of a plurality of pixels before and after the luminance on/off state change point detected by the luminance on/off state change detecting unit, and the display device is configured such that a pixel value interchange range across pixels whose tone values are to be interchanged is controlled according to the amount of motion.

According to the display device of this invention, it is possible to achieve the effect of dynamic false contour noise reduction.

### BRIEF DESCRIPTION OF THE DRAWINGS

FIGS. 1A and 1B are a diagram to explain a gradation expression method based on a subframe technique and a diagram to explain why a dynamic false contour noise is produced;

FIG. 2 is a schematic diagram showing a PDP device which is a display device pertaining to the present invention;

FIGS. 3A and 3B are block diagrams to explain image processing, pertaining to a first embodiment of the present invention;

FIGS. 4A, 4B, and 4C are pattern diagrams to explain dynamic false contour noise reduction processing, pertaining to the first embodiment of the present invention;

FIGS. 5A and 5B are pattern diagrams presenting another example of pixel interchanging, pertaining to the first embodiment of the present invention;

FIGS. 6A and 6B are graphs plotting luminance values which are visually sensed, as the line of sight moves under a first condition, pertaining to the first embodiment of the present invention;

FIGS. 7A and 7B are graphs plotting luminance values which are visually sensed, as the line of sight moves under a second condition, pertaining to the first embodiment of the present invention;

FIGS. 8A and 8B are graphs plotting luminance values which are visually sensed, as the line of sight moves under a third condition, pertaining to the first embodiment of the present invention;

FIGS. 9A and 9B are graphs plotting luminance values which are visually sensed, as the line of sight moves under a fourth condition, pertaining to the first embodiment of the present invention;

FIGS. 10A and 10B are block diagrams to explain image processing, pertaining to a second embodiment of the present invention;

FIGS. 11A, 11B, and 11C are pattern diagrams to explain dynamic false contour noise reduction processing, pertaining to the second embodiment of the present invention;

FIGS. 12A and 12B are graphs plotting luminance values which are visually sensed, as the line of sight moves, to explain improvement by processing differently performed for each frame, pertaining to the second embodiment of the present invention; and

FIGS. 13A and 13B are block diagrams to explain image processing, pertaining to a third embodiment of the present invention.

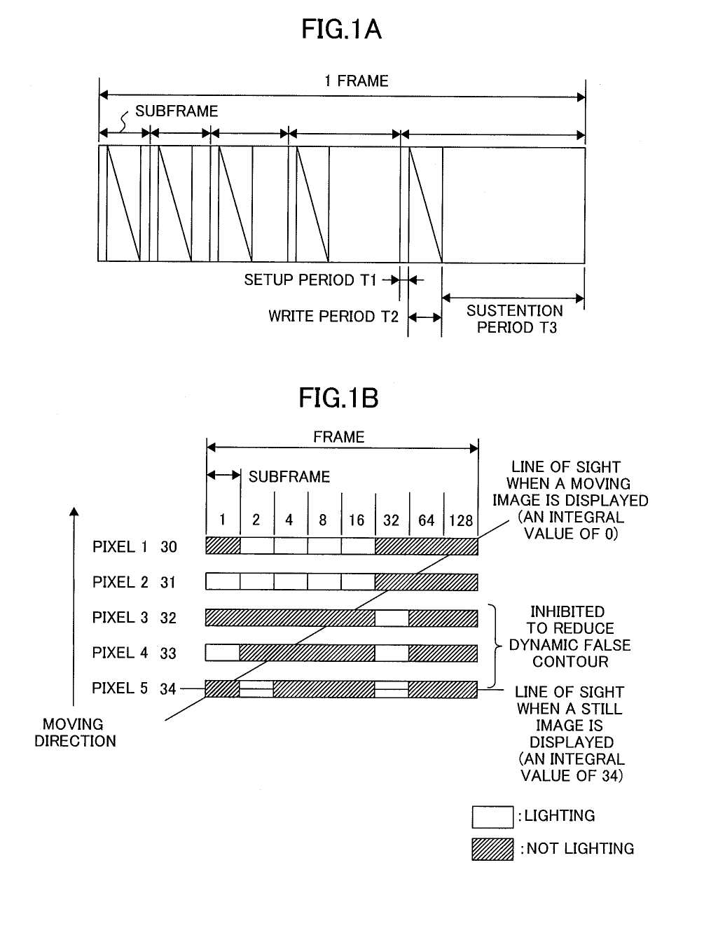

Embodiments of the present invention will now be described hereinafter with reference to the drawings.

### FIRST EMBODIMENT

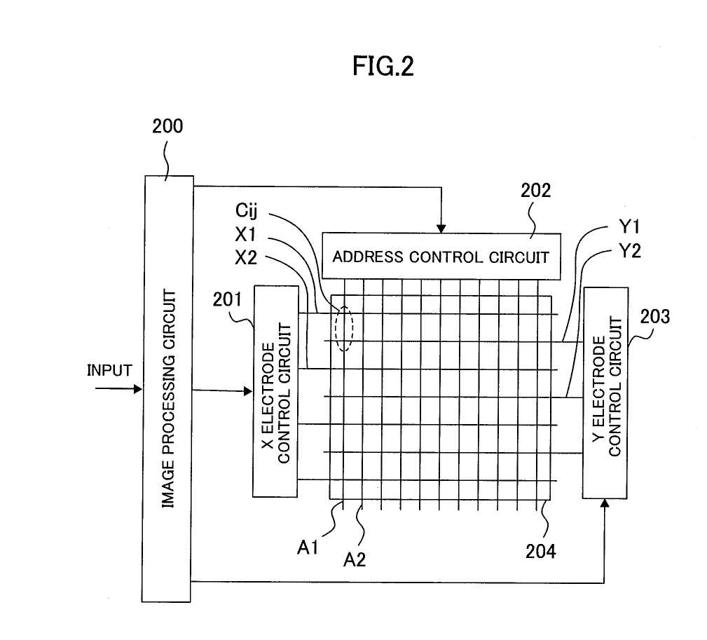

FIG. 2 is a bock diagram showing an outline structure of a PDP device in a first embodiment. A plasma display panel 204 consists of two substrates having a plurality of X electrodes (X1, X2, . . . ) and a plurality of Y electrodes (Y1, Y2, . . . ) which are arranged alternately side by side as well as a plurality of address electrodes arranged in a direction intersecting the X and Y electrodes at a right angle provided on the substrates. Phosphors are disposed in crossing sections of these electrodes and a gas for discharge is enclosed within the space between the two electrodes. An address electrode driving circuit 202 applies address pulses and the like to the address electrodes and a Y electrode control circuit 203 applies progressive scanning pulses to the Y electrodes and also applies sustained discharge pulses in conjunction with an X electrode control circuit 201. An image processing circuit 200 performs conversion of an input image into a form capable of being input to each control circuit, among others, and controls the above-mentioned components.

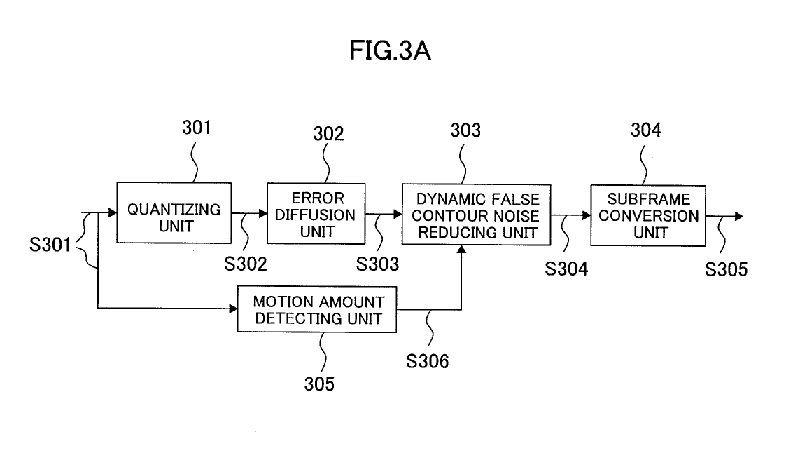

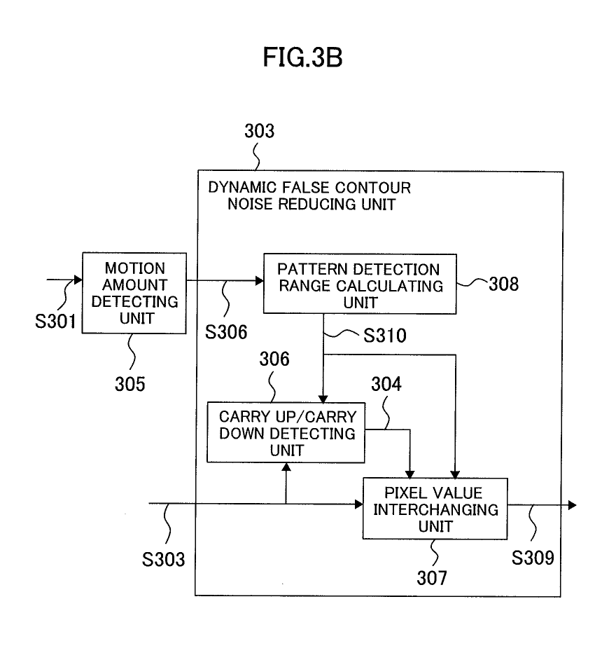

FIG. 3A shows an outline diagram of processing which is performed by the image processing circuit 200 in FIG. 2. In FIG. 3A, an input image signal S301 which is supplied from outside is input to a quantizing unit 301 and a motion amount predicting unit 305.

In the subframe technique, there are some lighting patterns inhibited from being used in order to reduce a dynamic false contour noise produced due to the fact that the line of sight of one who viewing a moving image keeps track of the motion of the image. The quantizing unit 301 performs quantization processing for this purpose. The quantizing unit 301 sends quantized tone values (referred to as real tones) and errors between the real tone values and tone values in the signal S301 as a signal S302 to an error diffusion unit 302. The error diffusion unit 302 expresses tones becoming undisplayable by the quantization as pseudo real tone values proportionally in the spatial arrangement of real tones. Resulting tone values of spatially arranged real tones by applying an error diffusion method are input as S303 to a dynamic false contour noise reducing unit 303.

The dynamic false contour noise reducing unit 303 receives S303 and S306 as inputs. Here, S306 is a result as the amount of motion of an original image detected by the motion amount detecting unit 305. The motion amount detecting unit 305 derives an input image signal for an image having three primary colors (referred to as an input image signal) and a timing signal (referred to as a sync signal) from the input signal S301 and detects the amount of motion from a current frame and its preceding frame on a per-pixel basis from the input image signal. Detecting the amount of motion is assumed to be carried out using a gradient method or the like, but there is no limitation to this.

The dynamic false contour noise reducing unit 303 detects particular patterns in the input signal S303 which a dynamic false contour noise occurs. A pattern range to be detected and a range within which noise reduction processing should be performed are controlled by an input signal S306. By spatially interchanging pixels in a detected pattern, a factor of producing a dynamic false contour noise is dispersed and the occurrence of a dynamic false contour noise is prevented. Since the pattern range to be detected and the range within which noise reduction processing should be performed are controlled by using the result of the detected amount of motion, it becomes possible to reduce the dynamic false contour noise produced depending on the amount of motion of the image. Concrete processing will be described later.

A signal S304 processed by the dynamic false contour noise reduction processing is sent to a subframe conversion unit 304. The subframe conversion unit 304 converts this signal into a signal S305 that can be input to the panel and outputs it to the panel. In the following paragraphs, the dynamic false contour noise reducing unit 303 in the present embodiment will be explained in detail, using FIGS. 3A, 3B, 4A, 4B, 4C, 5A, 5B, 6A, 6B, 7A, 7B, 8A, and 8B.

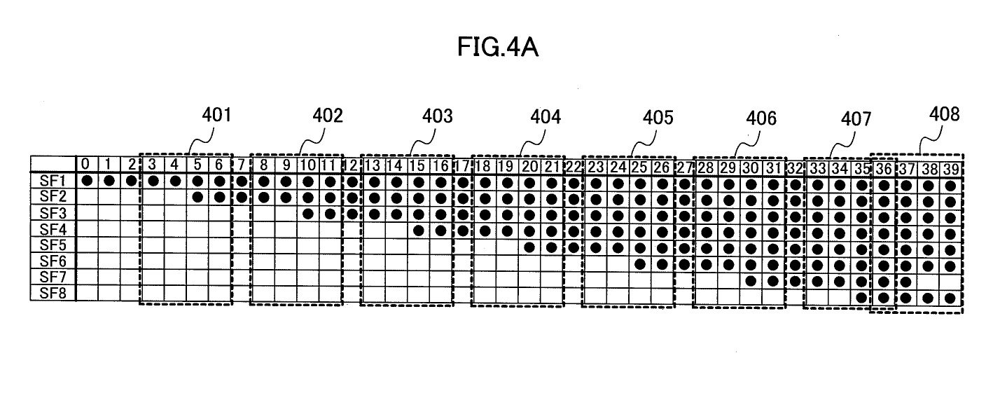

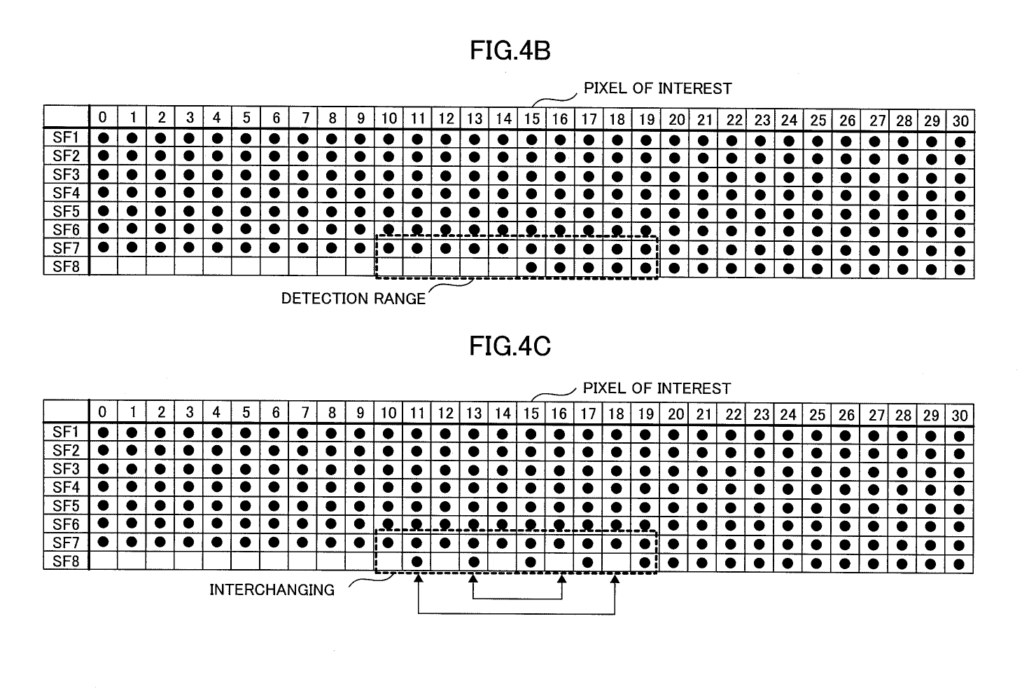

In the present invention, the dynamic false contour noise is reduced, while maintaining the tone values of an original image. In the lighting patterns of given pixels, a portion inducing a dynamic false contour noise is a portion where a subframe having the largest weight among subframes in which pixels are lighted up undergoes a spatially smooth change such that it includes luminance on/off state change (luminance on/off state change (carry up/carry down). The dynamic false contour noise inducing patterns are shown in FIG. 4A. In FIG. 4A, a horizontal direction corresponds to an x coordinate in an image and, in a vertical direction, turning a pixel on in each subframe (SF) is indicated, thereby representing the tone values of pixels arranged on the x coordinate. FIG. 4A illustrates a case where the tone values smoothly increase with an increase in the x coordinate. In the present embodiment, in regions undergoing a smooth tone level change in the lighting patterns of the pixels, regions where a subframe having the largest weight among subframes in which pixels are lighted up includes luminance on/off state change (carry up/carry down) are detected as portions (patterns) inducing a dynamic false contour noise. In FIG. 4A, regions 401, 402, 403, 404, 405, 406, and 407 are detected as dynamic false contour noise inducing patterns.

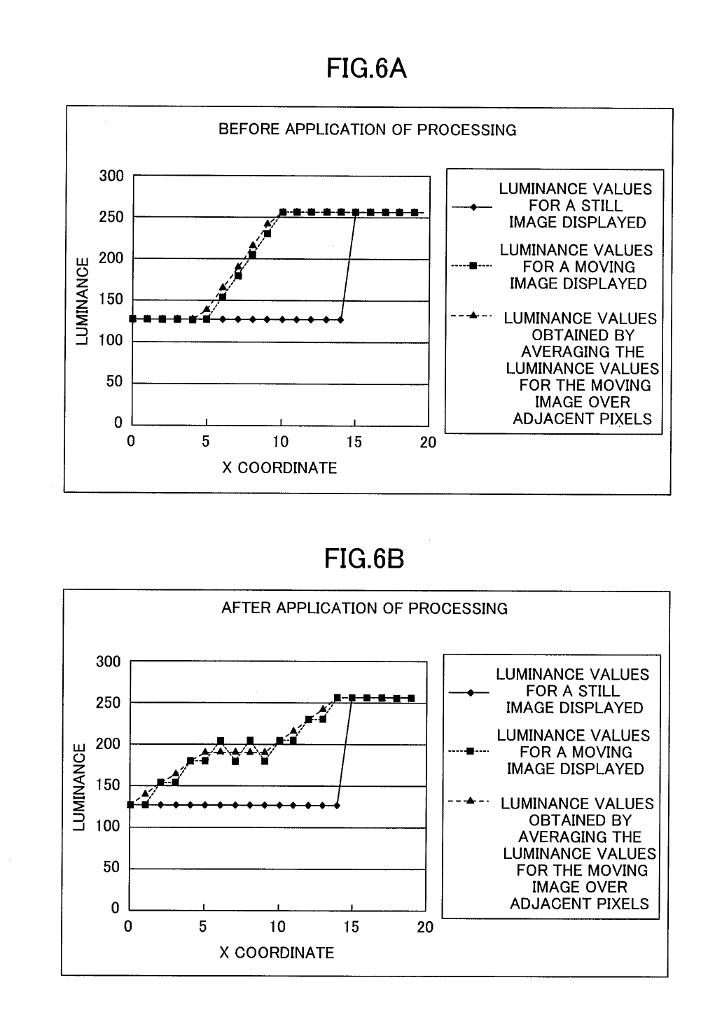

Then, FIG. 4B presents a result of detecting a pattern where tone values smoothly increase in a subframe 7 and a subframe 8, similarly to the region 407 in FIG. 4A, with a detection range of 10 pixels. FIG. 6A represents transition of visually sensed luminance values when the image with the lighting patterns shown in FIG. 4B moves by 10 pixels per frame. In FIG. 6A, the abscissa corresponds to the x-direction coordinate and visually sensed tone values in a range of 0 to 255 are plotted on the ordinate. With regard to FIGS. 6A and 6B, it is assumed that the subframes have luminance weights, respectively, which are weighted by powers of two in order; i.e., SF1=1, SF2=2, SF3=4, SF4=8, SF5=16, SF6=32, SF7=64, and SF8=128. In FIG. 6A, rhombic dots denote luminance values for a still image displayed, square dots denote luminance values which are visually sensed by integrating the pixel values in the direction of the line of sight when the image is moving by 10 pixels per frame, and triangle dots denote luminance values obtained by averaging the visually sensed luminance values denoted by the square dots over contiguous pixels. By the motion added, the luminance values visually sensed for the moving image displayed steeply change relative to the luminance values visually sensed for a still image in a section between x-coordinates 5 and 10. On the other hand, the luminance of the original image changes at x-coordinate 15. Hence, there is a significant difference between the visually sensed luminance and the luminance of the original image in a section between x-coordinates 10 and 15. A state that the luminance of the moving image steeply changes and has a large difference from the luminance of the original image continues, with the result that such state is visually sensed as a dynamic false contour noise. Accordingly, as shown in FIGS. 4A and 4B, in a region where tone values increase or decrease smoothly and where the subframe of the largest weight includes luminance on/off state change (carry-up or carry-down), a dynamic false contour noise takes place and this region is thus detected as a dynamic false contour noise inducing pattern.

FIG. 3B shows a detailed block diagram of the dynamic false contour noise reducing unit 303 included in FIG. 3A. An original image signal S301 is input to the motion amount detecting unit 305. The motion amount detecting unit 305 detects the motion amount of the image from the signal S301 and its preceding signal and sends the thus detected motion amount as S306 to a pattern detection range calculating unit 308. The motion amount detecting unit 305 detects the amount of motion by the gradient method or the like, but there is no limitation to this.

The pattern detection range calculating unit 308 calculates a pattern range to be processed, which is required for processing by a luminance on/off state change detecting unit 306 and a pixel value interchanging unit 307, and outputs a signal S310. The pattern range to be processed is set equal to or larger than the detected motion amount, as will be described later.

S303 is a signal resulting from multiple tone processing applied by the error diffusion unit 302 and the signal S303 is input to the luminance on/off state change detecting unit 306 and the pixel value interchanging unit 307. The luminance on/off state change detecting unit 306 receives S303 and S310 as input signals. Based on the pattern detection range S310 calculated by the pattern detection range calculating unit 308, the luminance on/off state change detecting unit 306 scans the lighting patterns in which tone values gradually increase or decrease, as shown in FIGS. 4A and 4B, included in the signal S303, and detects a region where a subframe having the largest weight among subframes in which pixels are lighted up includes luminance on/off state change (carry-up or carry-down). It sends a signal S308 to the pixel value interchanging unit 307, if having detected a luminance on/off state change (carry-up or carry-down) portion.

The pixel value interchanging unit 307 rearranges the tone values of pixels in the detected pattern, thus preventing the occurrence of a dynamic false contour noise. In the case where, e.g., a pattern in the range shown in FIG. 4B has been detected as a dynamic false contour noise inducing pattern, the pixel value interchanging unit 307 interchanges the lighting patterns for the pixels at x-coordinates 11 and 18 and the pixels at x-coordinates 13 and 16, as in FIG. 4C. Thereby, the tone values of the pixels in the range in subframes 7 and 8 in which a smooth transition of tone values was observed are scrambled, with the result that these pixels are alternately turned on and off in the higher-order frame. This enables dispersing the main factor of producing a dynamic false contour noise and achieves dynamic false contour noise reduction. Because the processing by the pixel value interchanging unit 307 interchanges the tone values of the pixels in a given range in the lighting patterns, an average luminance value within the processed region is preserved.

In the present embodiment, the detection range of a dynamic false contour noise inducing pattern was assumed to be the same as the range of pixel value interchange processing. If the range of pixel value interchange processing is larger than the detection range of a dynamic false contour noise inducing pattern, there is a possibility that the pixels in a pattern without a dynamic false contour noise are subjected to the processing. If the range of pixel value interchange processing is smaller than the detection range of a dynamic false contour noise inducing pattern, the pixel value interchange processing results in insufficient dispersion of the factor of producing a dynamic false contour noise and dynamic false contour noise reduction is not well effected. Hence, such problem can be resolved by making the detection range of a dynamic false contour noise inducing pattern equal to the range of pixel value interchange processing.

FIG. 6B represents a result of dynamic false contour noise reduction processing by interchanging the pixel values in the present embodiment. In FIG. 6B, rhombic dots denote luminance values for a still image displayed, square dots denote luminance values which are visually sensed when the image is moving by 10 pixels per frame, and triangle dots denote luminance values obtained by averaging the visually sensed luminance values denoted by the square dots over contiguous pixels. Looking at the luminance values after the occurrence of a dynamic false contour noise and the luminance values averaged over contiguous pixels, in comparison to the graph of FIG. 6A for the image not subjected to dynamic false contour noise reduction processing, luminance gradually rises in a section between x-coordinates 0 and 15. Difference of luminance from the original image becomes smaller than that observed in the graph of FIG. 6A. Thus, a steep change of luminance and a persistent large difference in luminance from the original image are moderated. Consequently, no dynamic false contour noise will be perceived visually. A smooth increase of tone values is reproduced and a high quality image is visually sensed.

As described above, in a region where tone values increase or decrease smoothly, by detecting a pattern that undergoes a transition such that a lighting pattern having the largest weight among subframes in which pixels are lighted up includes luminance on/off state change (carry-up or carry-down) as a factor of producing a dynamic false contour noise and interchanging the tone values of the pixels in the detected pattern, it is possible to reduce the dynamic false contour noise. However, the above-described condition assumes the case where the image is moving by 10 pixels per frame and the pattern detection range and the interchange processing range are 10 pixels. But, the motion amount of a moving image is not constant and there are some cases where the motion amount is larger or smaller than the pattern detection range and the interchange processing range. In such cases, as the human eye sees an image portion not subjected to dynamic false contour noise reduction processing, the viewer visually perceives a dynamic false contour noise and feels lowering of image quality. Therefore, in order to accomplish dynamic false contour noise reduction, it is needed clearly define relations of the motion amount to the pattern detection range and the interchange processing range and confine the conditions for application of the processing. Relations of the motion amount to the pattern detection range and the interchange processing range are confined to the following three relations: (1) Motion amount=Pattern detection range and Interchange processing range; (2) Motion amount<Pattern detection range and Interchange processing range; and (3) Motion amount>Pattern detection range and Interchange processing range.

With respect to the foregoing three relations, the relations of the motion amount to the pattern detection range and the interchange processing range will be explained below, using FIGS. 6A, 6B, 7A, 7B, 8A, 8B, 9A, and 9B.

First, an explanation will be given with regard to the relation (1), using FIG. 6B. FIG. 6B is the graph plotting luminance values that are visually sensed, if the motion amount equals to the detection range, where the motion amount is 10 pixels per frame and the pattern detection range and the interchange processing range are 10 pixels. As already noted, in comparison to the graph of FIG. 6A, a moderate change of visually sensed luminance values is observed in FIG. 6B and a persistent large difference in luminance from the original image is lessened. Thus, no dynamic false contour noise is visually perceived and a high quality image is provided. Accordingly, when there is the relation that the motion amount is equal to the detection range, dynamic false contour noise reduction is achieved. Hence, in the case of the relation (1), dynamic false contour noise is reduced.

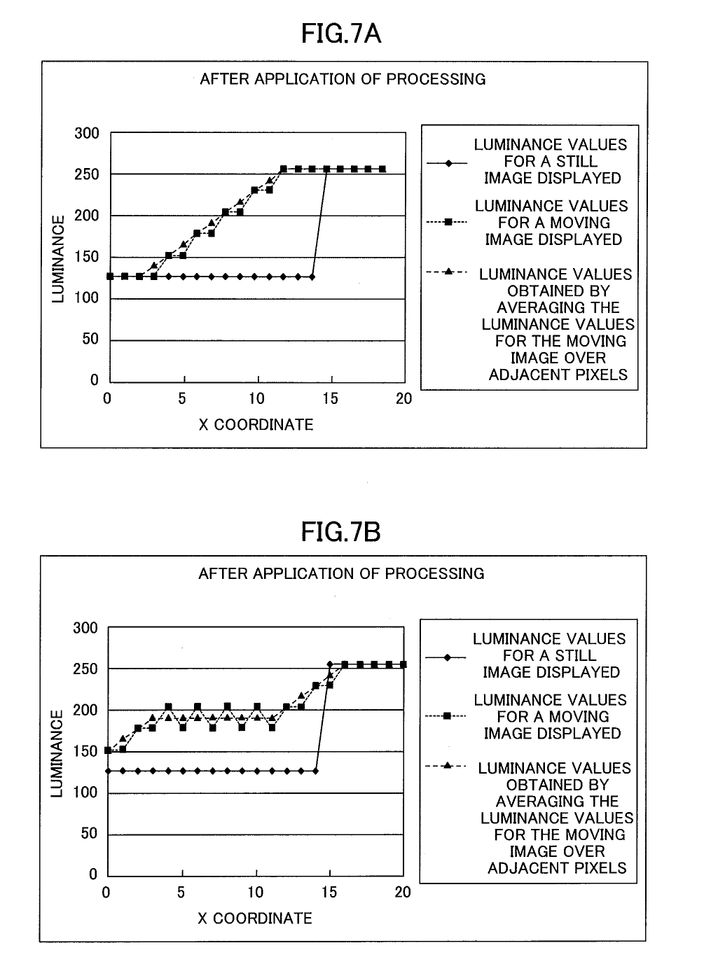

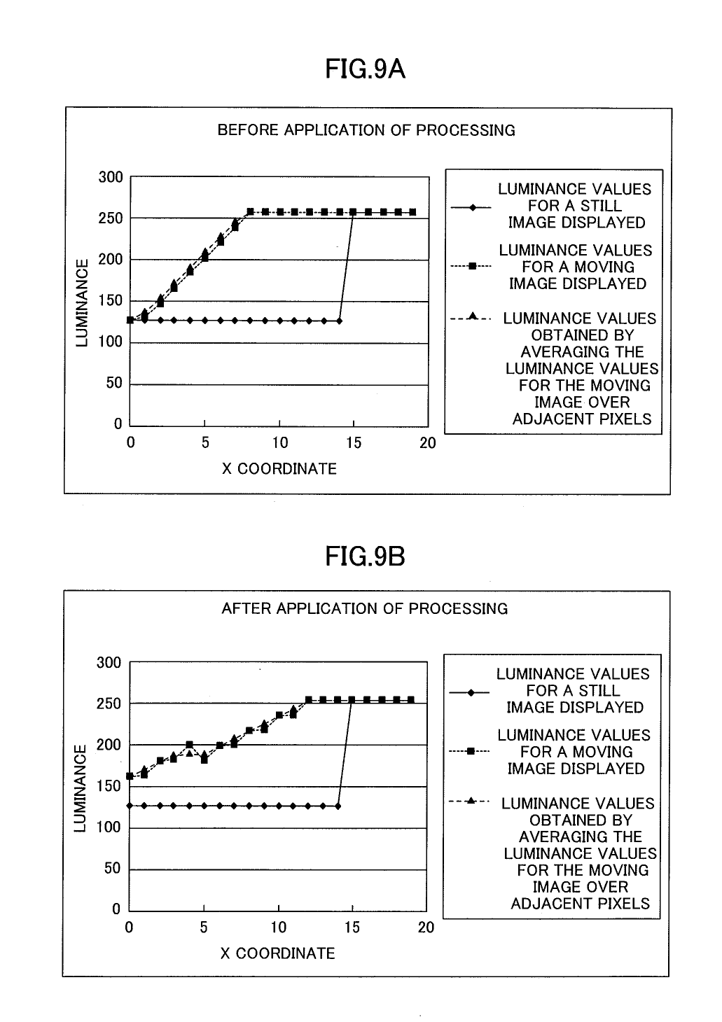

Next, an explanation will be given with regard to the relation (3), using FIGS. 7A, 9A, and 9B.

FIG. 7A is a graph plotting luminance values that are visually sensed, if the motion amount is larger than the detection range, where the motion amount is 10 pixels per frame and the pattern detection range and the interchange processing range are 6 pixels. In FIG. 7A, the visually sensed luminance steeply changes in a section between x-coordinates 3 and 12 and a large difference between the visually sensed luminance values and the luminance of the original image is observed in a section between x-coordinates 13 and 15. In comparison of the result of FIG. 7A to FIG. 6B, the visually sensed luminance rises steeply and a large difference in luminance from the original image is observed for a longer period. In the case of FIG. 7A, a dynamic false contour noise is perceived and lowering in image quality occurs.

FIGS. 9A and 9B represent results, where the motion amount is 14 pixels per frame and the pattern detection range and the interchange processing range are 10 pixels. FIG. 9A is a graph plotting luminance values that are visually sensed before the image is subjected to. The visually sensed luminance value rises steeply in a section between x-coordinates 0 and 7 and a maximum difference in luminance from the original image is observed in a section between x-coordinates 8 and 15. FIG. 9B is a graph of a result of the dynamic false contour noise reduction processing. Although luminance rises gradually in a section between x-coordinates 0 and 12, there is a period when a maximum difference in visually sensed luminance from the original image is observed in a section between x-coordinates 13 and 15. Hence, a dynamic false contour noise is visually perceived and, therefore, image quality varies depending on the motion amount.

According to the foregoing, under the condition where the relation (3) is true for a moving image at, e.g., the motion amount in regard to FIG. 7A as well as the motion amount in regard to FIGS. 9A and 9B, a dynamic false contour noise occurs. Hence, in the case of the relation (3), a dynamic false contour noise occurs and image quality is degraded.

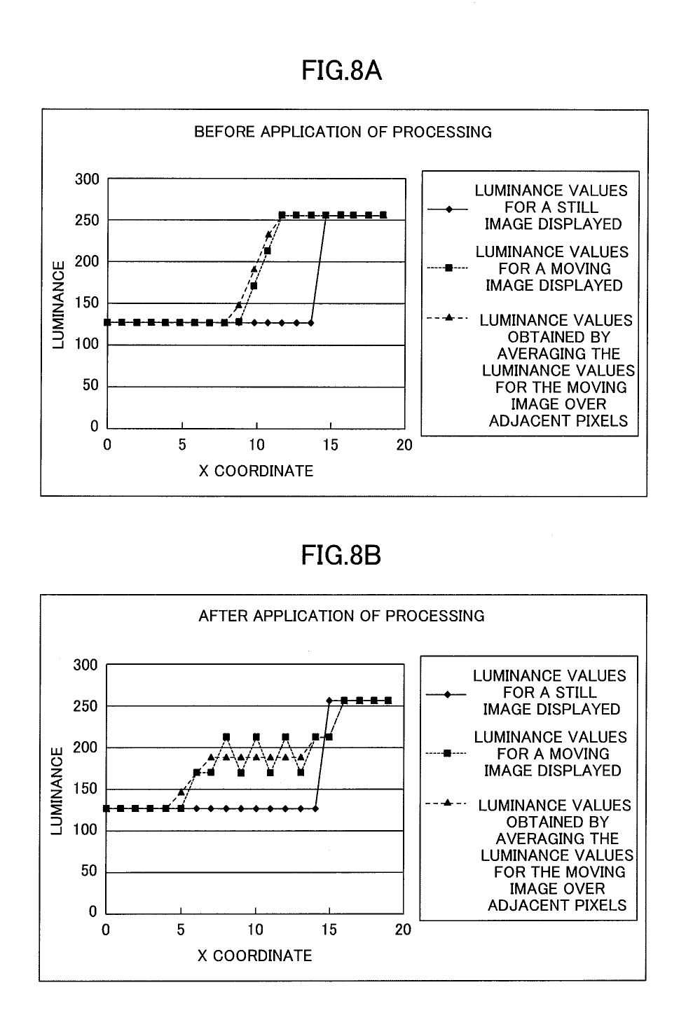

Next, an explanation will be given with regard to the relation (2), using FIGS. 7B, 8A, and 8B.

FIG. 7B is a graph of a result of the dynamic false contour noise reduction processing, if the pattern detection range and the interchange processing range are larger than the motion amount, where the motion amount is 10 pixels per frame and the pattern detection range and the interchange processing range are 14 pixels. In FIG. 7B, the visually sensed luminance rises gradually in a section between x-coordinates 0 and 16. There is no period when a large difference in visually sensed luminance from the original image is observed. Hence, a dynamic false contour noise is hard to perceive and dynamic false contour noise reduction is accomplished. Thus, in the case where the pattern detection range and the interchange processing range are larger than the motion amount, it is possible to provide a high quality image without a dynamic false contour noise and without variation in image quality depending on the motion amount of the image.

FIGS. 8A and 8B are graphs plotting luminance transitions when the detection range is fixed to 10 pixels and the motion amount is 6 pixels per frame. FIG. 8A is a graph plotting luminance values that are visually sensed before the image is subjected to the dynamic false contour noise reduction processing. The visually sensed luminance value rises steeply in a section between x-coordinates 8 and 12 and a large difference in luminance from the original image is observed in a section between x-coordinates 13 and 15. FIG. 8B is a graph of a result of the dynamic false contour noise reduction processing. Luminance rises gradually in a section between x-coordinates 4 and 16 and there is no period when a maximum difference in luminance from the original image is observed.

Hence, a dynamic false contour noise is hard to perceive and dynamic false contour noise reduction is accomplished. Accordingly, even if the motion amount varies, by setting the pattern detection range and the interchange processing range equal to or larger than the motion amount, it is possible to provide a high quality image without variation in image quality depending on the motion amount.

According to the foregoing, under the condition where the relation (2) is true for a moving image at, e.g., the motion amount in regard to FIG. 7B as well as the motion amount in regard to FIGS. 8A and 8B, the dynamic false contour noise reduction processing produces the effect of dynamic false contour noise reduction and dynamic false contour noise reduction can be achieved.

The results explained above indicate that the dynamic false contour noise reduction processing is effective for the relation (1), i.e., the dynamic false contour noise reduction processing range is equal to the motion amount or the relation (2), i.e., the above range is larger than motion amount. However, the dynamic false contour noise reduction processing performed in the range smaller than the motion amount (relation (3)) does not achieve dynamic false contour noise reduction and results in degradation of image quality. Accordingly, in the present invention, the relations (1) and (2) are adopted as the conditions for controlling the range of the dynamic false contour noise reduction processing depending on the motion amount in the dynamic false contour noise reduction processing.

In the present embodiment, the amount of motion of the original image is detected by the motion amount detecting unit 305 and the processing range within which the dynamic false contour noise reduction processing should be performed is determined by the pattern detection range calculating unit 308 according to the detected motion amount. The pattern detection range calculating unit 308 defines a range that is larger than the motion amount, according to the above relations between the image motion and the detection range. In the present embodiment, the above range is assumed to be set to comply with the conditions of (1) and (2), as explained above, in the pattern detection range calculating unit 308.

As described above, in the present embodiment, the detected amount of motion of the original image signal is used and the range of a region within which the factor of producing a dynamic false contour noise is detected and corrected can be controlled according to the motion amount of the original image. The dynamic false contour noise reduction processing is thus carried out and variation in image quality depending on the motion amount can be reduced.

Although an example where the detection range is 4 pixels is presented in FIG. 4A, the range is not so limited. FIGS. 4A, 4B, and 4C illustrates cases where lighting patterns are detected, wherein the pixels are turned on in all subframes other than a subframe having the largest weight among subframes in which pixels are lighted up. However, lighting patterns to be processed are not so limited. Even if subsets of pixels are turned off in the subframes of smaller weights, the processing unit detects luminance on/off state change (carry-up or carry-down) in the subframe having the largest weight as a dynamic false contour noise inducing pattern. Further, the processing unit may target not only turn-on or turn-off pixels in the subframe of the largest weight, but also luminance on/off state change (carry-up or carry-down) in a subframe of the second largest weight next to the subframe having the largest weight among subframes in which pixels are lighted up to provide a display gradation. For example, in a region 408 in FIG. 4A, the pixels are turned on equally in the subframe having the largest weight, whereas in the subframe of the second largest weight, the pixels at x-coordinates 36 and 37 are turned on, but the pixels at x-coordinates 38 and 39 are turned off. In the case where the processing unit targets not only turn-on or turn-off pixels in the subframe of the largest weight, but also luminance on/off state change (carry-up or carry-down) in the subframe of the second largest weight next to the subframe having the largest weight among subframes in which pixels are lighted up to provide a display gradation, the processing unit detects a pattern exemplified by the region 408 as a dynamic false contour noise inducing pattern.

As a way of interchanging pixels in the foregoing embodiment, when interchanging pixel values to change a state in FIG. 4B to a state in FIG. 4C, an interchange processing has been illustrated such that the pixel interchanging unit interchanges the tone values of each pair of pixels before and after the center pixels 14 and 15. In particular, the tone values of pixels 13 and 16 are interchanged and the tone values of pixels 12 and 17 are interchanged. In this way, the tone values of each pair of pixels at an equal distance from the center two pixels are interchanged. This interchange processing is performed for all pixels falling within the pixel value interchange range defined based on the detected motion amount.

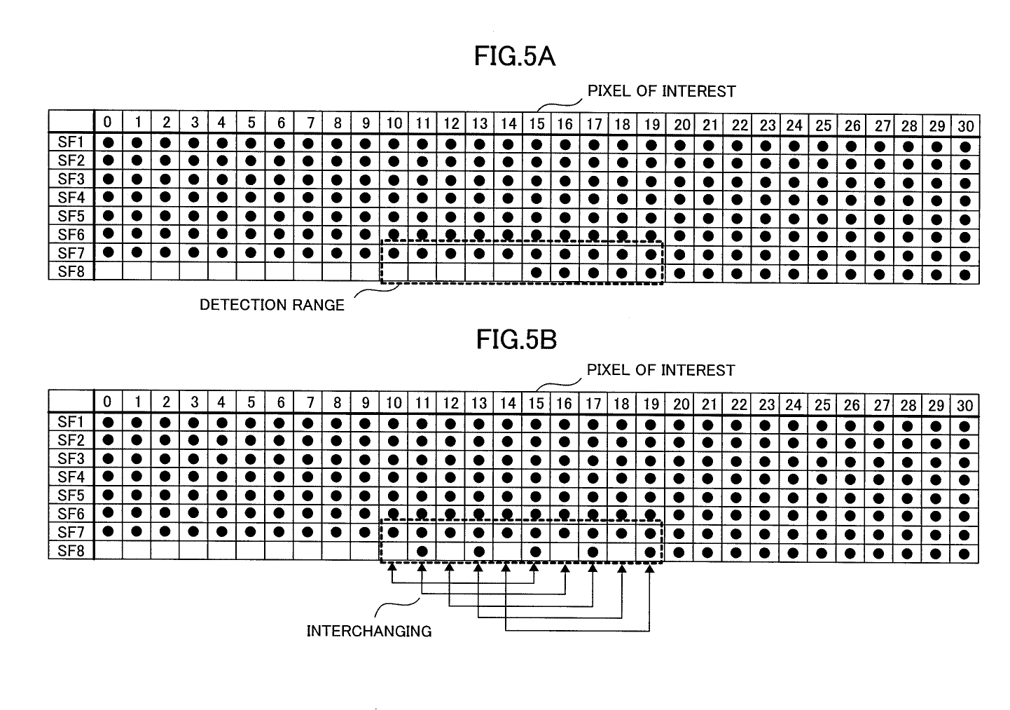

However, the present invention does not limit pixel interchange to the above-described way of interchange. For example, as illustrated in FIG. 5B, another way of interchange is also applicable in which tone value interchange is performed between two pixels separated by an equal interval over the interchange range. In this case, the interval between two pixels whose values are interchanged may be set arbitrarily. However, as illustrated in FIG. 5B, it is preferable to set the interval to a half of the detection range indicated in FIG. 5A based on the detected motion amount. By interchanging the tone values of the pixels in this way, a distance between pixels whose values are interchanged seldom varies for different pairs of pixels and lowering in image quality can be suppressed to a minimum.

Further, in a case where the portions of luminance on/off state change (carry-up or carry-down) in two adjacent subframes are very close to each other and the pixel value interchange ranges of the two subframes calculated from the detected amount of motion by the motion amount detecting unit are overlapped, their pixel value interchange ranges may be combined and pixel value interchange may be performed in the combined range. Even in such a case, because the pixel value interchange range never become narrower than the motion amount detected by the motion amount detecting unit, it is possible to achieve the effect of dynamic false contour noise reduction.

### SECOND EMBODIMENT

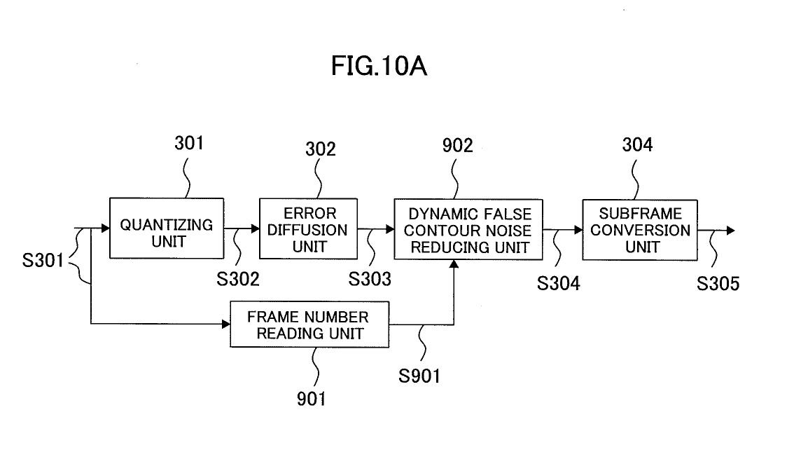

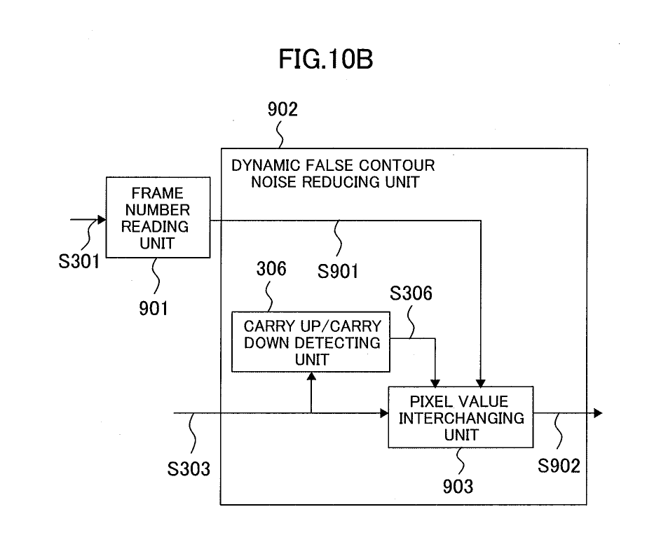

Next, a second embodiment of the present invention is described, using FIGS. 10A and 10B. FIG. 10A shows an outline diagram of processing which is performed by the image processing circuit 200 in the second embodiment. FIG. 10B is a block diagram showing a frame number reading unit 901 and processing of a dynamic false contour noise reducing unit 902 controlled by the frame number reading unit 901.

First, an original image signal S301 is input to the frame number reading unit 901. The frame number reading unit 901 reads the frame number of an original image signal and outputs the thus read frame number as a signal 5901. The signal S901 is input to a pixel value interchanging unit 903 and the pixel value interchanging unit 903 changes the way of interchanging pixel values in a lighting pattern according to the signal S901. Through this manner in which processing is changed according to the frame number, if, for example, processing is changed over between an even-numbered frame and an odd-numbered frame, it becomes feasible that an image in frame n and an image in frame n+1 are subjected to different ways of processing. Noise reduction processing can be performed in the space domain as well as the time domain. This accomplishes reducing image quality degradation occurring due to that identical patterns continue over a plurality of frames.

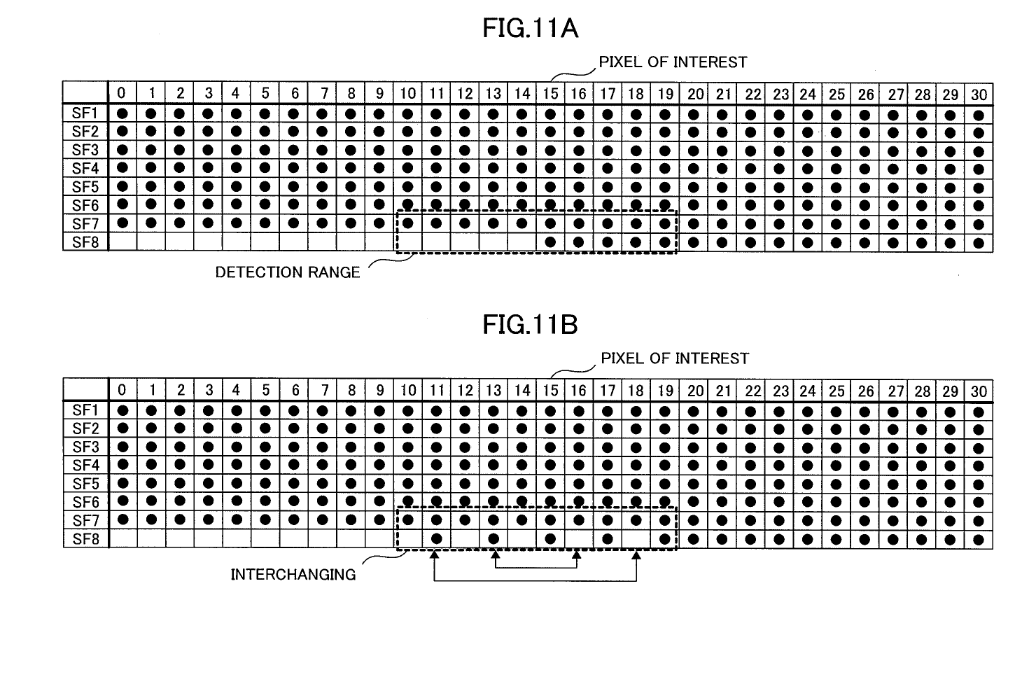

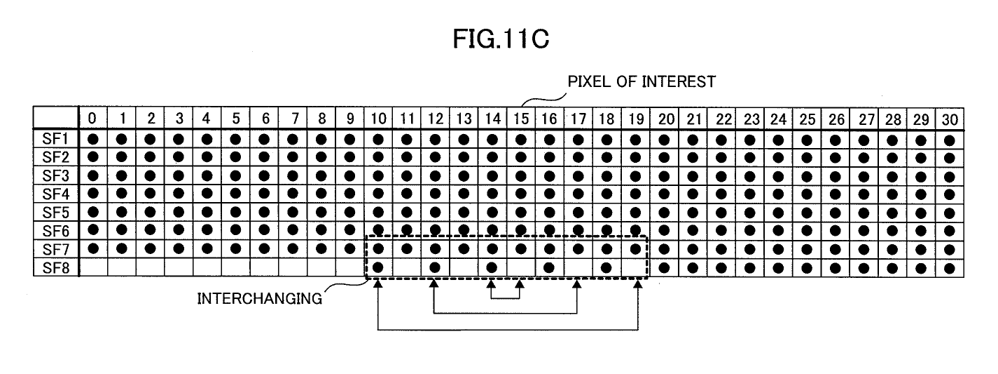

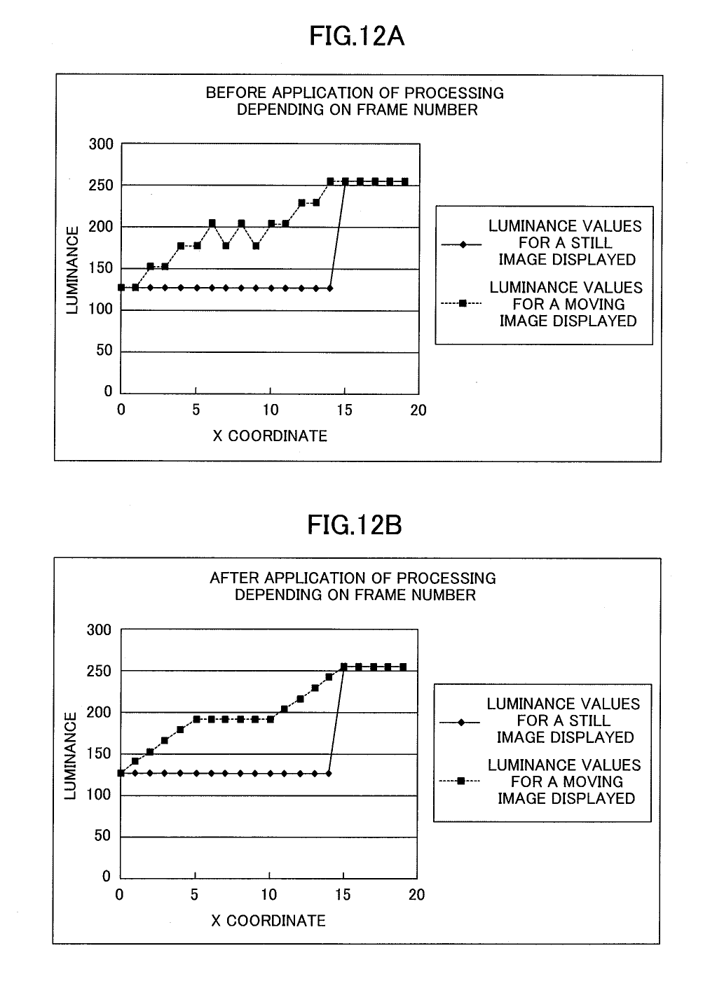

The pixel value interchanging unit 903 is explained, using FIGS. 11A, 11B, 11C, 12A, and 12B. FIG. 11A illustrates a case where the detection range is 10 pixels with respect to a pixel of interest and a subframe having the largest weight among subframes in which the pixels in the lighting patterns are lighted up includes luminance on/off state change (carry up/carry down) and undergoes a smooth transition, wherein the luminance on/off state change (carry up/carry down) portion is detected as a dynamic false contour noise inducing pattern.

FIG. 11B illustrates a result of processing the pattern detected in FIG. 11A by the dynamic false contour noise reduction processing when the frame number is even. On the other hand, FIG. 11C illustrates a result of processing the pattern detected in FIG. 11A by the dynamic false contour noise reduction processing when the frame number is odd. The interchange operation is arranged such that, after interchanging the tone values of the pixels in the corresponding lighting pattern, the altered pixels in the lighting pattern of the subframe of the largest weight are not the same in FIG. 11B and FIG. 11C.

Then, the effect of the processing in the present embodiment is explained, using FIGS. 12A and 12B. FIG. 12A is a graph plotting luminance values visually sensed when the image whose lighting patterns are shown in FIG. 11B is moving by 10 pixels per frame to the right and averaged over a plurality of frames. Transition of luminance values is observed in a section between x-coordinates 1 and 14, but its increasing tendency is not constant and luminance values increase/decrease in the rising gradient. Here, FIG. 12A represents a result of the processing according to the first embodiment. As already described, the processing unit detects the dynamic false contour noise inducing pattern and disperses it in the space domain by pixel value interchange processing. Thus, noise reduction in the space domain is achieved, but smooth gradation expression in the time domain is not achieved, because dispersion in the time domain is not carried out.

On the other hand, FIG. 12B is a graph plotting luminance values visually sensed when the image is moving at rate of 10 pixels per frame to the right and averaged over a plurality of frames, when the different ways of interchange processing illustrated in FIG. 11B and FIG. 12B were alternately applied to succeeding frames 1 and 2 on the time axis. While the visually sensed luminance values in FIG. 12A show a fluctuating transition and a smooth change is not observed, the visually sensed luminance values in FIG. 12B show a smooth transition. In this way, by controlling the pixel value interchanging unit 903 depending on each of succeeding frames on the time axis, smooth gradation expression becomes possible.

By changing interchange processing for each of succeeding frames on the time axis processing, as noted above, it is possible to reduce a noise occurring due to that identical tone patterns continue over a plurality of frames in the time domain, when the same interchange processing is applied to all frames. Noise reduction is carried out in the space domain as well as the time domain and a high quality image is provided.

A feature of the present embodiment has been described by taking an example where, the frame number reading unit 901 reads a frame number which is even or odd and, depending on the even or odd frame number, the pixel value interchanging unit 903 changes the direction of tone value interchange and arranges the interchange operation such that altered pixels in the corresponding lighting pattern are not the same for even-numbered and odd-numbered frames. However, the present invention is not so limited. It is obvious that interchange processing arranged to change the way of interchanging pixel values in turn for every 4-frame cycle or 8-frame cycle is also applicable.

### THIRD EMBODIMENT

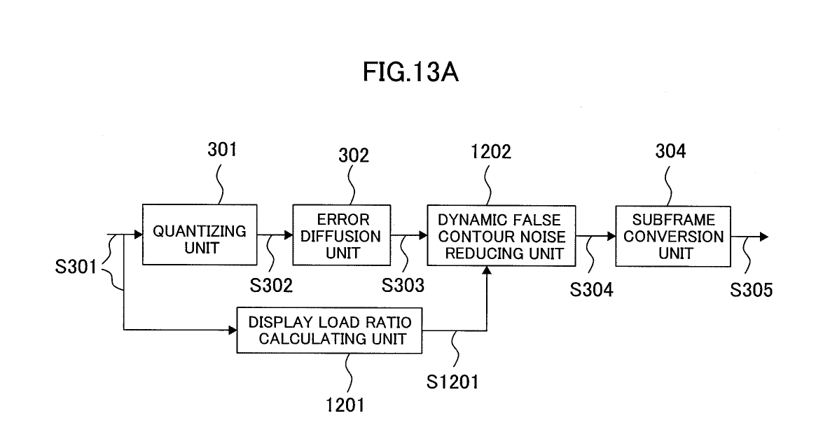

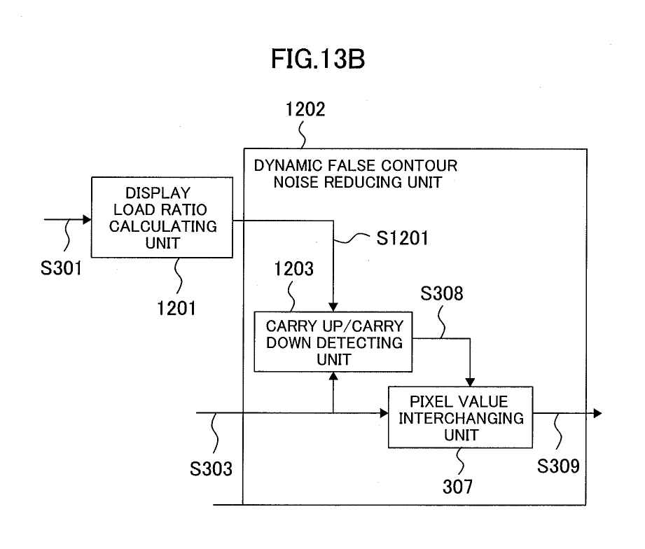

Next, a third embodiment of the present invention is described, using FIGS. 13A and 13B. FIG. 13A shows an outline diagram of processing of the present embodiment.

FIG. 13B shows a display load ratio calculating unit 1201 included in FIG. 13A and a structure for processing of a dynamic false contour noise reducing unit 1202 controlled by the display load ratio calculating unit 1201.

An input image signal 5201 is input to the display load ratio calculating unit 1201 and this unit calculates a display load ratio of the input image. The display load ratio of is calculated by the following Equation 1.

$$Display Load Ratio = \frac{{\sum }_{x = 0}^{M - 1} {\sum }_{y = 0}^{N - 1} R ( x , y ) + G ( x , y ) + B ( x , y )}{3 \times M \times N \times 255} \qquad Equation 1$$

In Equation 1, R, G, B denote luminance values of each color component at a coordinate (x, y), respectively, wherein each luminance value assumes a value in a range of 0-255, and M, N denote a total number of pixels in the x direction and a total number of pixels in the y direction, respective.

The calculated display load ratio is input as a signal S1201 to a luminance on/off state change detecting unit 1203. The luminance on/off state change detecting unit 1203 detects a dynamic false contour noise inducing pattern from the input signal S303. In the present embodiment, the luminance on/off state change detecting unit 1203 controls target subframes in which a noise-inducing portion should be detected according to the signal S1202, when determining a dynamic false contour noise inducing pattern. In particular, it targets only subframes of larger weights when the display load ratio is high and targets subframes of larger to smaller weights when the display load ratio is low. More specifically, among regions 401 to 407 illustrated in FIG. 4A as those involving a factor of producing a dynamic false contour noise, when the display load ratio is high, the luminance on/off state change detecting unit 1203 targets the regions 406 and 407 to detect such factor, and when the display load ratio is low, it targets the regions 403 to 407 to detect such factor.

Then, an explanation is given about the display load ratio and the occurrence of a dynamic false contour noise. In the PDP, the number of sustention cycles varies depending on the display load ratio. As the display load ratio increases, the number of sustention cycles inserted in each subframe decreases and the display luminance decreases. Even when pixels having the same tone values are displayed, their display luminance values may change, because the number of assigned sustention cycles differs due to different display load ratios.

The contrast sensitivity of human vision lowers with decreasing luminance. Consequently, when the display load ratio is high, the display luminance decreases and the contrast sensitivity also lowers. Due to this, there occurs a phenomenon in which a dynamic false contour noise visually perceived when the display load ratio is low is not perceived when the display load ratio is high. Therefore, in some of the regions as illustrated in FIG. 4A as those involving a factor of producing a dynamic false contour noise, a dynamic false contour noise may not actually occur, depending on the display load ratio of an original image signal. In that event, noise reduction processing on the pixels in a region inducing no dynamic false contour noise may alter image quality. Hence, by controlling the dynamic false contour noise reduction processing depending on the display load ratio of an original image signal, it becomes possible to select only the patterns including luminance on/off state change (carry-up or carry-down) in the subframes showing a luminance difference which is visually sensed as a dynamic false contour noise as targets of the dynamic false contour noise reduction processing.

In particular, if the display load ratio is low, the number of sustention cycles insertable in each subframe increases, which in turn increases luminance and contrast sensitivity, among the regions 401 to 407 shown in FIG. 4A as those involving a factor of producing a dynamic false contour noise, the regions 403 to 407 are selected as the targets. That is, the subframes having smaller to larger weights are selected as the targets. By contrast, when the display load ratio is high, the number of sustention cycles insertable in each subframe decreases, which in turn decrease luminance. Because the contrast sensitivity lowers with decreasing luminance, among the regions 401 to 407 shown in FIG. 4A as those involving a factor of producing a dynamic false contour noise, the regions 406 and 407 are selected as the targets. That is, since a dynamic false contour noise in subframes of smaller weights will not be visually perceived due to lowing in the contrast sensitivity, these subframes are deselected as targets.

As above, by calculating the display load ratio of an input image and changing the target subframes by using the load ratio, it becomes possible to select only those subframes that undergo a transition perceived as a dynamic false contour noise as target patterns in which a noise-inducing portion should be detected and processed by the dynamic false contour noise reduction processing. The dynamic false contour noise reduction processing can be carried out on only noise-inducing regions, a high quality image is provided.

In the above-describe processing, the regions 406 and 407 are selected as the targets when the display load ratio is high and the regions 403 to 407 are selected when display load ratio is low. However, this is not restrictive and it is possible to select, for example, the regions 405 and 406 as the targets when the display load ratio is high. Since the relation between display load ratio and luminance values changes depending on the panel on which images are to be displayed, the targets may be changed accordingly.

In the above-described third embodiment, the processing is performed based on the display load ratio, but this is not restrictive, and an index relating to display luminance may be used. For example, based on an average luminance level, a histogram of an original image, etc., the luminance on/off state change detecting unit may be controlled.

The present invention provides the aspects of dynamic false contour noise reduction processing as described in the first, second, and third embodiments. However, it is not restrictive that each aspect of this processing is performed independently; combinations of these aspects may be carried out. In a case where the first and second embodiments are combined, the detection range of patterns inducing a dynamic false contour noise and the range of dynamic false contour noise reduction processing by interchanging the tone values of pixels can be set properly according to the detected amount of motion and, furthermore, the operation of the pixel value interchanging unit can be switched depending on the frame number in accordance with the second embodiment. Noise reduction is achieved in the space domain as well as the time domain. Therefore, by combining the first embodiment and the second embodiment, dynamic false contour noise reduction can be achieved more preferably than when each embodiment is performed independently.

Next, another case is discussed where a combination of the first embodiment and the third embodiment is carried out. In the first embodiment, the detection range for detecting a factor of a dynamic false contour noise and the range within which interchanging the tone values of pixels is performed can be set properly according to the detected amount of motion. The third embodiment is capable of restricting subframes in which dynamic false contour noise reduction processing should be performed depending on a display load ratio. Thus, by combining the first embodiment and the third embodiment, only patterns inducing a dynamic false contour noise are selected as targets in an original image and these patterns can be subjected to the dynamic false contour noise reduction processing within an optimum range of processing. Therefore, by combining the first embodiment and the third embodiment, dynamic false contour noise reduction can be achieved more preferably than when each embodiment is performed independently.

In a case where the second embodiment and the third embodiment are combined, luminance on/off state change (carry-up or carry-down) portions in subframes including a dynamic false contour noise inducing pattern can only be processed according to the third embodiment and different ways of interchanging the tone values of pixels are performed for each frame according to the second embodiment. Thus, noise reduction can be achieved in the space domain as well as the time domain and dynamic false contour noise reduction can be achieved more preferably than when each embodiment is performed independently.

Further, it is also possible to combine the first, second, and third embodiment. By combining the three embodiments, an optimum detection range can be set according to the motion of an original image, subframes including a dynamic false contour noise inducing pattern can only be selected as targets according to the display load ratio of an original image, and noise reduction can be achieved in the space domain as well as the time domain by changing the way of interchanging the tone values of pixels for each frame. Dynamic false contour noise reduction can be achieved more preferably than when each embodiment is performed independently.

The present invention can be utilized in a plasma display module for television sets, among others.

What is claimed is:

1. A display device for displaying a gradation by making up one frame of a plurality of subframes having different weights of luminance and combining luminances of the subframes, the display device comprising:
a motion amount detecting unit that detects an amount of motion of an input image to be displayed;
a luminance on/off state change detecting unit that detects a luminance on/off state change point of per-pixel lighting in at least a subframe having the largest weight of luminance among subframes in which contiguous pixels are lighted up; and
a pixel value interchanging unit that interchanges the tone values of a plurality of pixels before and after the luminance on/off state change point detected by the luminance on/off state change detecting unit,
wherein the display device is configured such that a pixel value interchange range across pixels whose tone values are to be interchanged is controlled according to the amount of motion.

2. The display device according to claim 1,
wherein the luminance on/off state change detecting unit detects a point where luminance on/off state change occurs simultaneously in both a subframe having the largest weight of luminance and a subframe having the second largest weight of luminance among subframes in which contiguous pixels are lighted up.

3. The display device according to claim 1, wherein a detection range for detecting the luminance on/off state change point is defined as follows:
if the motion amount of an input image to be displayed is larger than a first threshold value, the detection of luminance on/off state change is performed within a first detection range; and
if the motion amount of an input image to be displayed is smaller than the first threshold value, the detection of luminance on/off state change is performed within a second detection range that is narrower than the first detection range.

4. The display device according to claim 1,
the detection range for detecting the luminance on/off state change point is equal to or wider than a range of motion corresponding to the detected motion amount.

5. The display device according to claim 1,
wherein the pixel value interchange range is equal to the detection range.

6. The display device according to claim 1,
wherein the pixel value interchanging unit interchanges the tone values of a plurality of pixels falling within the pixel value interchange range to disperse their luminances across the pixels.

7. The display device according to claim 1,
wherein the pixel value interchanging unit interchanges the tone values of pixels, keeping the sum of the number of turn-on pixels unchanged in a plurality of subframes including a plurality of pixels falling within the pixel value interchange range.

8. The display device according to claim 1,
the pixel value interchanging unit interchanges the tone values of different pixels alternately for each of a plurality of succeeding frames on a time axis.

9. The display device according to claim 1,
the pixel value interchanging unit interchanges the tone values of different pixels alternately for succeeding first and second frames on the time axis.

10. A display device for displaying a gradation by making up one frame of a plurality of subframes having different weights of luminance and combining luminances of the subframes, the display device comprising:
a display load ratio calculating unit that calculates a display load ration based on an input image signal;
a luminance on/off state change detecting unit that detects a luminance on/off state change point of per-pixel lighting in at least a subframe having the largest weight of luminance among subframes in which contiguous pixels are lighted up; and
a pixel value interchanging unit that interchanges the tone values of a plurality of pixels before and after the luminance on/off state change point detected by the luminance on/off state change detecting unit,
wherein, the number of subframes targeted by the luminance on/off state change detecting unit for detection is controlled, based on the display load ratio calculated by the display load ratio calculating unit.

11. The display device according to claim 10,
wherein the luminance on/off state change detecting unit targets a subframe having the largest weight among subframes in which contiguous pixels are lighted up and detects the luminance on/off state change point in the subframe, if the display load ratio is higher than a first threshold value, and
wherein the luminance on/off state change detecting unit targets both a subframe having the largest weight and a subframe having the second largest weight among subframes in which contiguous pixels are lighted up and detects the luminance on/off state change point in both subframes, if the display load ratio is lower than the first threshold value.

12. The display device according to claim 10, further comprising a motion amount detecting unit that detects an amount of motion of the input image to be displayed;
wherein a pixel value interchange range across pixels whose tone values are to be interchanged is controlled according to the amount of motion.

13. A display device for displaying a gradation by making up one frame of a plurality of subframes having different weights of luminance and combining luminances of the subframes, the display device comprising:
a luminance on/off state change detecting unit that targets a subframe having the largest weight among subframes in which contiguous pixels are lighted up and detects a luminance on/off state change point of per-pixel lighting in the subframe, if an average value of display luminance given in an input image signal is lower than a first threshold value, and targets both a subframe having the largest weight and a subframe having the second largest weight among subframes in which contiguous pixels are lighted up and detects the luminance on/off state change point in both subframes and detects a luminance on/off state change point of per-pixel lighting in both the subframes, if the average value of display luminance is higher than the first threshold value; and
a pixel value interchanging unit that interchanges the tone values of a plurality of pixels before and after the luminance on/off state change point detected by the luminance on/off state change detecting unit.
